(19) United States
(12) Patent Application Publication
(10) Pub. No.: US 2018/0318989 A1
(43) Pub. Date: Nov. 8, 2018

(54) WRENCH

(71) Applicant: Li-Ching Lin, Taichung (TW)

(72) Inventor: Li-Ching Lin, Taichung (TW)

(21) Appl. No.: 15/587,404

(22) Filed: May 5, 2017

(51) Int. Cl. B25B 23/00; B25B 13/46

(52) U.S. Cl. CPC B25B 23/0035; B25B 13/462

(57) ABSTRACT

A wrench includes a wrench body, a ratchet wheel, a locking member and a connecting implement. The ratchet wheel is rotatably mounted on the wrench body and provided with two slots. The connecting implement is mounted on the ratchet wheel and provided with a retaining groove. The locking member is movably mounted on the ratchet wheel and has two locking portions mounted in the two slots of the ratchet wheel and locked in the retaining groove of the connecting implement. In such a manner, the wrench only needs to provide a single locking member, thereby decreasing the cost of fabrication.

### BACKGROUND OF THE INVENTION

### 1. Field of the Invention

The present invention relates to a hand tool and, more particularly, to a ratchet wrench.

### 2. Description of the Related Art

A conventional wrench in accordance with the prior art was disclosed in U.S. Pat. No. 9,498,869, entitled “Socket Wrench”, comprising a wrench body 30, a ratchet wheel 31, a positioning ring 32, and an elastic member 33. The ratchet wheel 31 has a driving hole 311, a flange 313 and an aperture 314. The positioning ring 32 has a central hole 321 mounted on the flange 313 of the ratchet wheel 31 and a protrusion 323 mounted in the aperture 314 of the ratchet wheel 31. A C-ring 316 is used to limit the positioning ring 32. A socket 40 is mounted on the ratchet wheel 31 and has a post 401 mounted in the driving hole 311 of the ratchet wheel 31. The post 401 of the socket 40 is positioned in the driving hole 311 of the ratchet wheel 31 by action of the positioning ring 32, the elastic member 33 and the C-ring 316. However, the conventional wrench needs to provide three members, including the positioning ring 32, the elastic member 33 and the C-ring 316, to mount the socket 40 on the ratchet wheel 31, thereby increasing the cost of fabrication. In addition, the positioning ring 32 is formed by stamping and needs other working procedures to form a noncircular recess 324 for receiving the elastic member 33, thereby greatly increasing the cost of production.

### SUMMARY OF THE INVENTION

The present invention is to mitigate and/or obviate the disadvantage of the conventional wrench.

In accordance with the present invention, there is provided a wrench comprising a wrench body, a ratchet wheel, a locking member, a first cover, a first snap ring, a second cover and a second snap ring. The wrench body is provided with a first receiving recess. The first receiving recess has a first end provided with a first abutting portion and a second end provided with a second receiving recess. The second receiving recess has a periphery provided with a first retaining groove. The ratchet wheel is rotatably mounted in the first receiving recess and has a periphery provided with a ratchet portion which has a second abutting portion abutting the first abutting portion. The ratchet wheel is provided with a recessed first mounting portion which has a plurality of concave portions and a plurality of convex portions arranged in an alternating manner. The convex portions are arranged in an inscribed circle of the first mounting portion. The ratchet wheel is provided with a column protruding from the first receiving recess. The column is provided with a second retaining groove. The column is provided with two first slots connected to the first mounting portion. Each of the two first slots has a length covering at least one of the concave portions and at least one of the convex portions. The ratchet wheel is provided with two third abutting portions. The locking member is movably mounted in the two first slots of the ratchet wheel. The locking member is elastic and has a

U-shaped profile. The locking member has an operation portion, two fourth abutting portions, two locking portions and two limit portions. The two fourth abutting portions abut the two third abutting portions. Each of the two fourth abutting portions has an oblique shape. The two locking portions extend into the inscribed circle of the first mounting portion. The two limit portions rest on the column. The first cover is mounted on the wrench body and covers the ratchet wheel and the locking member, with the second retaining groove and the operation portion protruding from the first cover. The first cover is provided with a receiving portion including two second slots and two third slots. The two second slots receive the two fourth abutting portions.

The two third slots receive the two limit portions. The first snap ring is mounted in the second retaining groove of the ratchet wheel and abuts the first cover. The second cover is mounted in the second receiving recess of the wrench body and abuts the ratchet wheel. The second snap ring is mounted in the first retaining groove of the wrench body and abuts the second cover.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wrench in accordance with the preferred embodiment of the present invention;

FIG. 2 is a top view of a ratchet wheel of the wrench in accordance with the preferred embodiment of the present invention;

FIG. 3 is a perspective view of a first cover of the wrench in accordance with the preferred embodiment of the present invention;

FIG. 4 is a perspective assembly view of the wrench in accordance with the preferred embodiment of the present invention;

FIG. 5 is a perspective view showing combination of the ratchet wheel and the locking member as shown in FIG. 1;

FIG. 6 is a perspective view showing combination of the first cover and the locking member as shown in FIG. 1;

FIG. 7 is a perspective view of a connecting implement in accordance with the preferred embodiment of the present invention;

FIG. 8 is a top view showing the wrench with the connecting implement;

FIG. 9 is a cross-sectional view of the wrench taken along line 9-9 as shown in FIG. 8;

FIG. 10 is a front view showing the wrench with the connecting implement;

FIG. 11 is a cross-sectional view of the wrench taken along line 11-11 as shown in FIG. 10;

FIG. 12 is a schematic operational view of the wrench as shown in FIG. 11;

FIG. 13 is a perspective view of a wrench in accordance with another preferred embodiment of the present invention;

FIG. 14 is a front view of a wrench in accordance with another preferred embodiment of the present invention;

FIG. 15 is a cross-sectional view of the wrench taken along line 15-15 as shown in FIG. 14;

FIG. 16 is a partially exploded perspective view of a wrench in accordance with another preferred embodiment of the present invention;

FIG. 17 is a front assembly view of the wrench as shown in FIG. 16, and

FIG. 18 is a cross-sectional view of the wrench taken along line 18-18 as shown in FIG. 17.

### DETAILED DESCRIPTION OF THE INVENTION

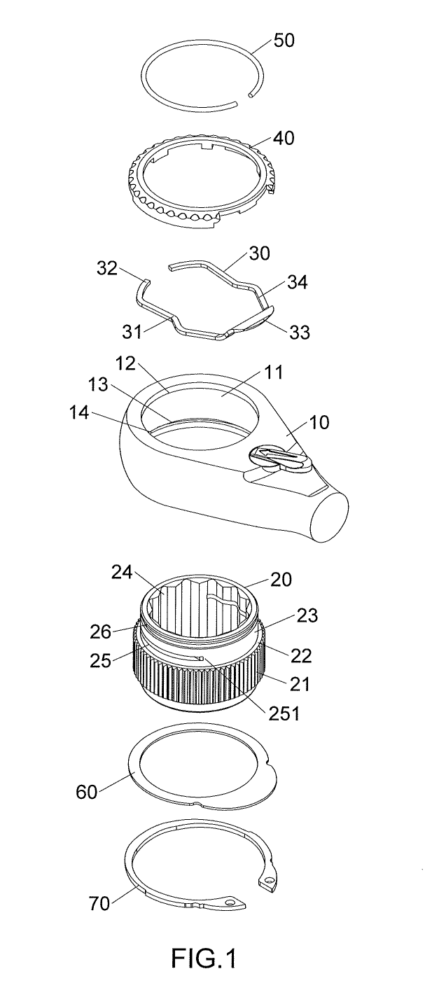

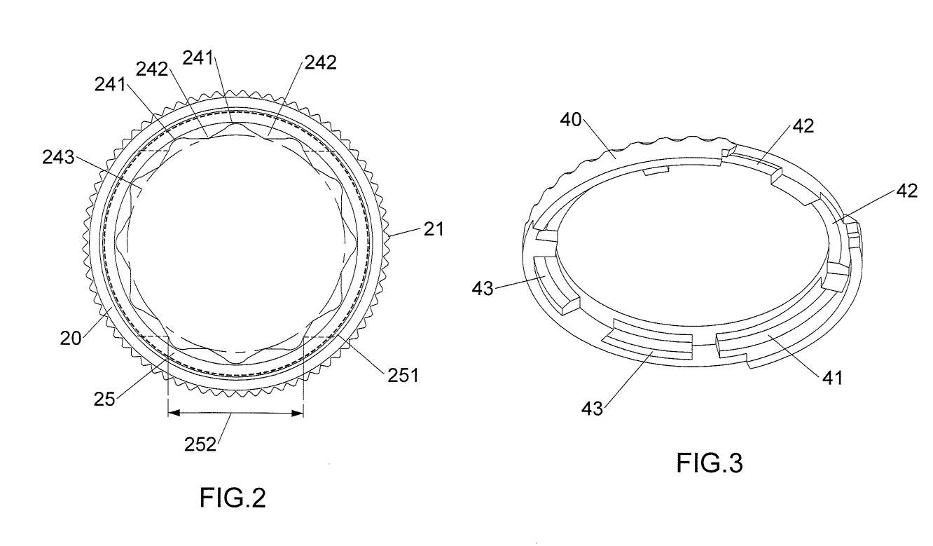

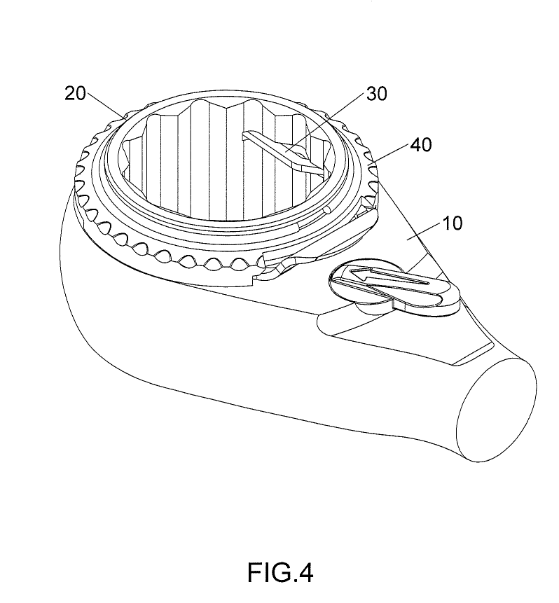

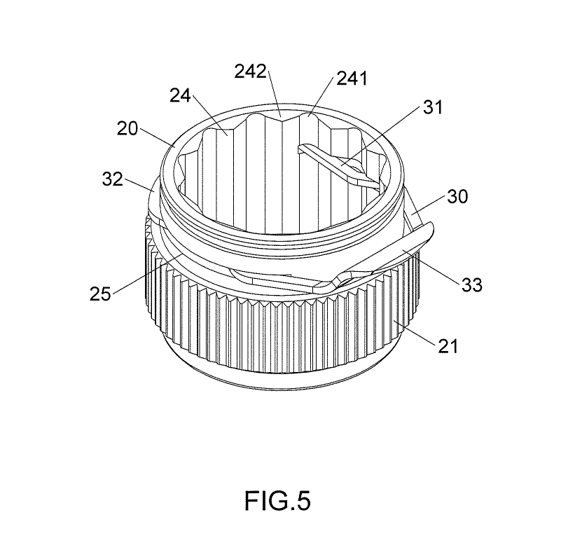

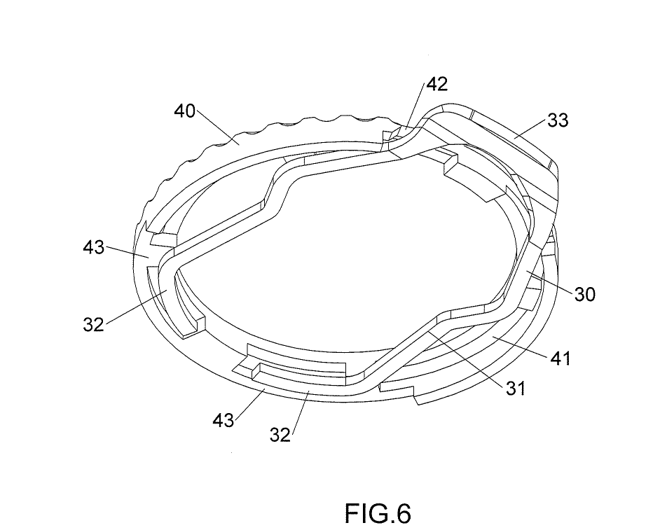

Referring to the drawings and initially to FIGS. 1-6, a wrench in accordance with the preferred embodiment of the present invention comprises a wrench body 10, a ratchet wheel 20, a locking member 30, a first cover 40, a first snap ring 50, a second cover 60 and a second snap ring 70. The wrench body 10 is provided with a first receiving recess 11 which has a circular shape and extends through the wrench body 10. The first receiving recess 11 has a first end provided with a first abutting portion 12 and a second end provided with a second receiving recess 13. The first abutting portion 12 has a diameter smaller than that of the first receiving recess 11. The second receiving recess 13 has a diameter greater than that of the first receiving recess 11 and has a periphery provided with a first retaining groove 14 having an annular shape.

The ratchet wheel 20 is rotatably mounted in the first receiving recess 11 and has a periphery provided with a ratchet portion 21 which has a second abutting portion 22 abutting the first abutting portion 12. The ratchet wheel 20 is provided with a recessed first mounting portion 24 which has a plurality of concave portions 241 and a plurality of convex portions 242 arranged in an alternating manner. Preferably, the first mounting portion 24 has a hexagonal or dodecagonal shape and extends through the ratchet wheel 20. The convex portions 242 are arranged in an inscribed circle 243 of the first mounting portion 24. The ratchet wheel 20 is provided with a column 23 protruding from the first receiving recess 11. The column 23 is provided with a second retaining groove 26 having an annular shape. The column 23 is provided with two first slots 25 connected to the first mounting portion 24. Each of the two first slots 25 has a length 252 covering at least one of the concave portions 241 and at least one of the convex portions 242. Preferably, the length 252 of each of the two first slots 25 covers three of the concave portions 241 and two of the convex portions 242. The ratchet wheel 20 is provided with two third abutting portions 251. Preferably, each of the two third abutting portions 251 is arranged on an arcuate face of the column 23 and located adjacent to one of the two first slots 25. Preferably, each of the two third abutting portions 251 has an arcuate shape.

The locking member 30 is movably mounted in the two first slots 25 of the ratchet wheel 20. The locking member 30 is elastic and has a U-shaped profile. The locking member 30 has an operation portion 33, two fourth abutting portions 34, two locking portions 31 and two limit portions 32. The locking member 30 is driven and moved by the operation portion 33. The two fourth abutting portions 34 abut the two third abutting portions 251. Each of the two fourth abutting portions 34 has an oblique shape. The two locking portions 31 extend into the inscribed circle 243 of the first mounting portion 24. The two limit portions 32 rest on the column 23 so that the locking member 30 is not detached from the ratchet wheel 20 by restriction of the two limit portions 32. Preferably, each of the two fourth abutting portions 34 is arranged between the operation portion 33 and one of the two locking portions 31, and each of the two locking portions 31 is arranged between one of the two fourth abutting portions 34 and one of the two limit portions 32.

In assembly of the locking member 30, the locking member 30 is initially expanded outward so that the locking member 30 is mounted in the two first slots 25 of the ratchet wheel 20. When the operation portion 33 of the locking member 30 is pushed, the locking member 30 is moved in the two first slots 25 of the ratchet wheel 20, so that the two fourth abutting portions 34 are moved to press the two third abutting portions 251, the two locking portions 31 are expanded outward to detach from the inscribed circle 243 of the first mounting portion 24, and the two limit portions 32 are spaced from the peripheral face of the column 23. When the operation portion 33 of the locking member 30 is released, the locking member 30 is returned automatically to the original position by action of the two fourth abutting portions 34 and the two third abutting portions 251.

The first cover 40 is mounted on the wrench body 10 and covers the ratchet wheel 20 and the locking member 30, so that the locking member 30 is partially hidden in the first cover 40, with the second retaining groove 26 and the operation portion 33 protruding from the first cover 40. The first cover 40 is provided with a receiving portion 41 including two second slots 42 and two third slots 43. The two second slots 42 receive the two fourth abutting portions 34. The two third slots 43 receive the two limit portions 32.

The first snap ring 50 is mounted in the second retaining groove 26 of the ratchet wheel 20 and abuts the first cover 40 so that the first cover 40 is not detached from the wrench body 10 and the ratchet wheel 20 by restriction of the first snap ring 50.

The second cover 60 is mounted in the second receiving recess 13 of the wrench body 10 and abuts the ratchet wheel 20 so that the ratchet wheel 20 is not detached from the wrench body 10 by restriction of the second cover 60. The second snap ring 70 is mounted in the first retaining groove 14 of the wrench body 10 and abuts the second cover 60 so that the second cover 60 is not detached from the wrench body 10 by restriction of the second snap ring 70.

In assembly, the ratchet wheel 20 is mounted in the first receiving recess 11 of the wrench body 10. Then, the locking member 30 is locked onto the ratchet wheel 20, with the two locking portions 31 of the locking member 30 extending through the two first slots 25 of the ratchet wheel 20. Then, the first cover 40 is mounted on the wrench body 10 to cover the ratchet wheel 20 and the locking member 30. Then, the first snap ring 50 is mounted in the second retaining groove 26 of the ratchet wheel 20 and abuts the first cover 40. Then, the second cover 60 is mounted in the second receiving recess 13 of the wrench body 10 and abuts the ratchet wheel 20. Then, the second snap ring 70 is mounted in the first retaining groove 14 of the wrench body 10 and abuts the second cover 60.

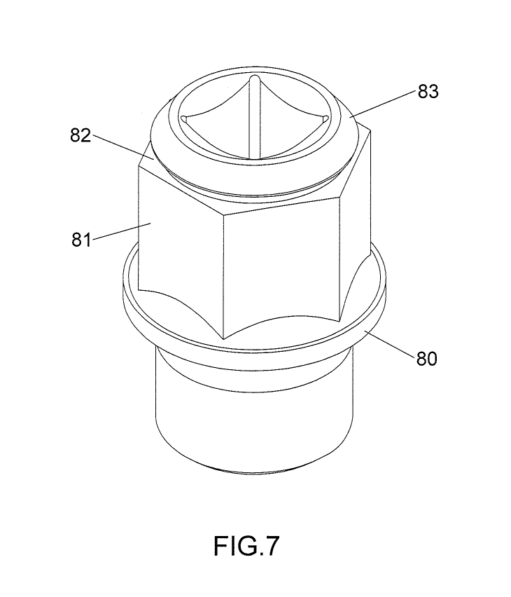

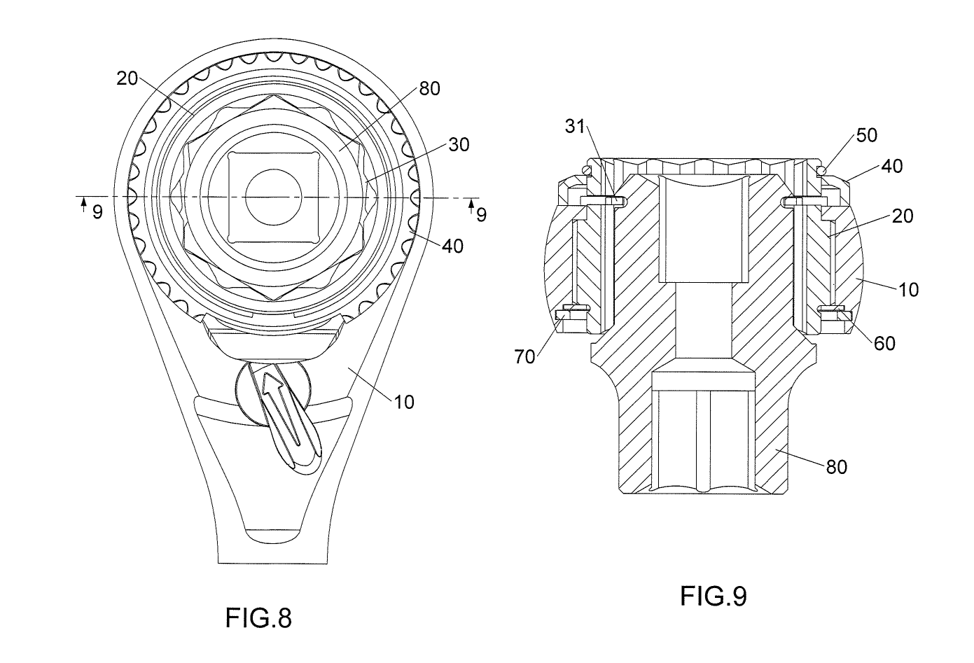

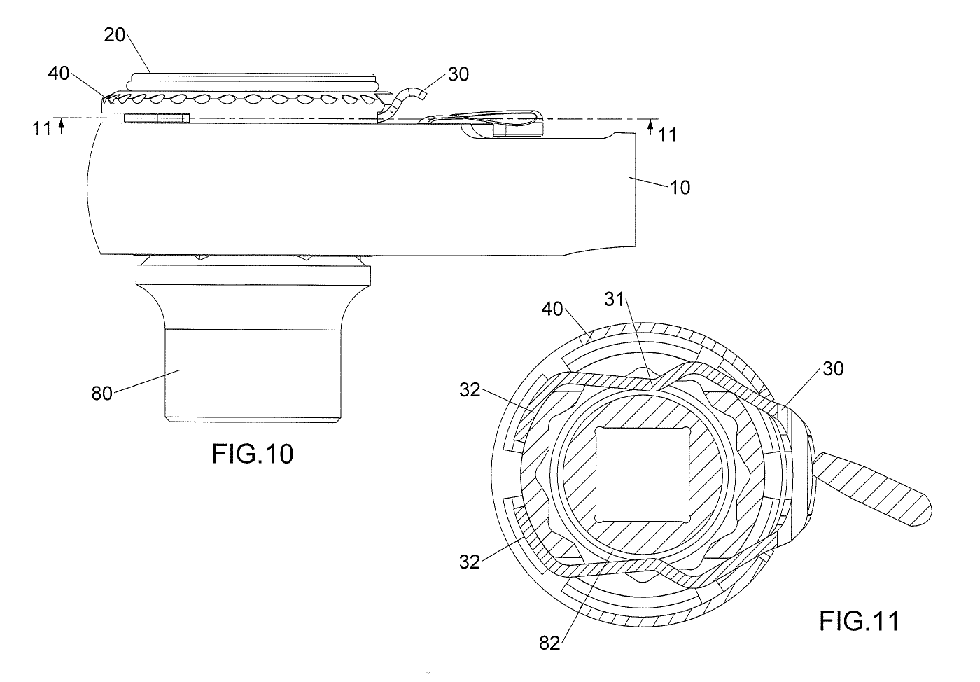

Referring to FIGS. 7-12, the wrench in accordance with the preferred embodiment of the present invention further comprises a connecting implement 80 mounted on the ratchet wheel 20. The connecting implement 80 is provided with a second mounting portion 81 mounted on the first mounting portion 24 of the ratchet wheel 20. The second mounting portion 81 is provided with a third retaining groove 82, and the two locking portions 31 of the locking member 30 are mounted in the two first slots 25 of the ratchet wheel 20 and the third retaining groove 82, so that the connecting implement 80 is not detached from the ratchet wheel 20 by restriction of the locking member 30. When the locking member 30 is moved in the two first slots 25 of the ratchet wheel 20, the two locking portions 31 are expanded outward to detach from the third retaining groove 82 so that the connecting implement 80 is detached from the ratchet wheel 20.

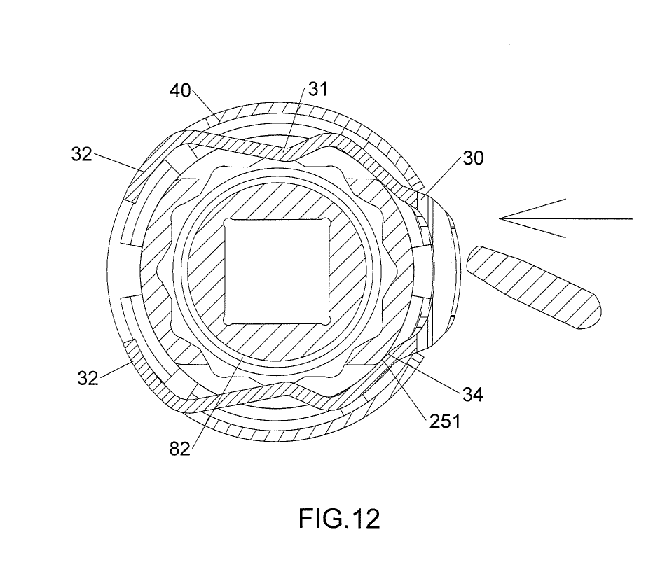

In practice, when the operation portion 33 of the locking member 30 is pushed in the direction indicated by the arrow shown in FIG. 12, the two fourth abutting portions 34 are pressed outward by the two third abutting portions 251, so that the two locking portions 31 are expanded outward and detached from the third retaining groove 82, thereby releasing the connecting implement 80 from the locking member 30, and thereby detaching the connecting implement 80 from the first mounting portion 24 of the ratchet wheel 20.

The connecting implement 80 is provided with a conic face 83. The third retaining groove 82 is located between the second mounting portion 81 and the conic face 83. When the connecting implement 80 is inserted into the ratchet wheel 20, the two locking portions 31 of the locking member 30 are expanded outward by the conic face 83 of the connecting implement 80 to facilitate insertion of the connecting implement 80 into the ratchet wheel 20 without having to move the locking member 30.

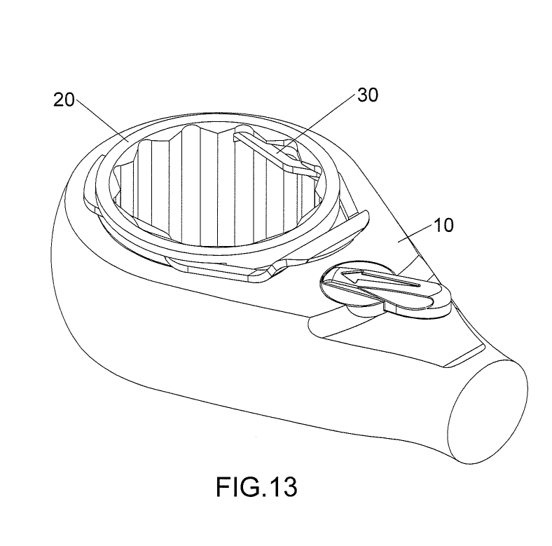

Referring to FIG. 13, the second retaining groove 26 of the ratchet wheel 20, the first cover 40 and the first snap ring 50 are undefined.

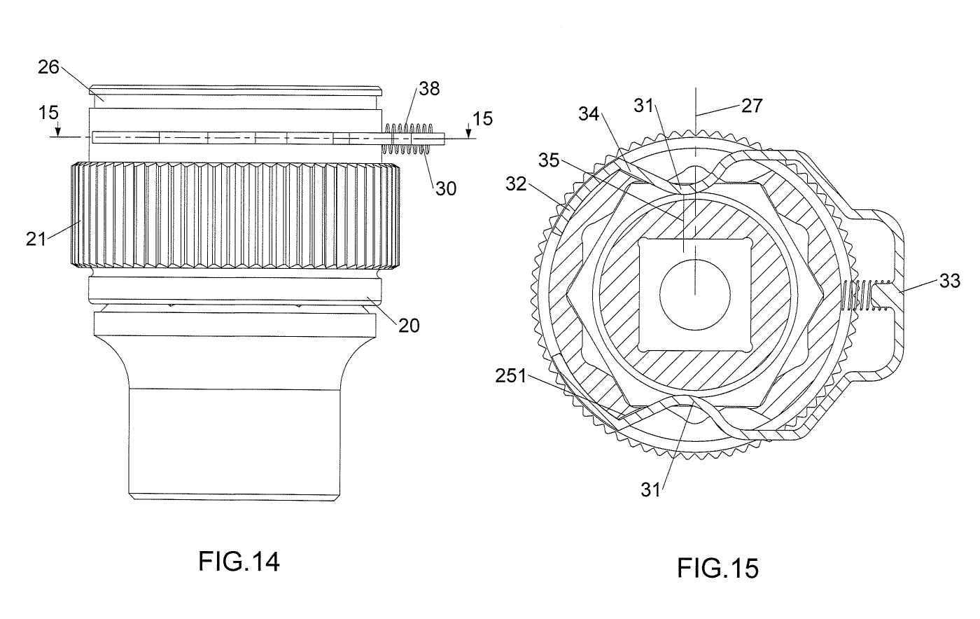

Referring to FIGS. 14 and 15, the ratchet wheel 20 is provided with a vertical line 27. Each of the two locking portions 31 of the locking member 30 has a projection provided with a normal line 35 which is spaced from the vertical line 27, with the vertical line 27 being located between the normal line 35 and the operation portion 33. Preferably, the length 252 of each of the two first slots 25 covers one of the concave portions 241 and two of the convex portions 242. Each of the two third abutting portions 251 is provided on a face of one of the two first slots 25. Each of the two fourth abutting portions 34 is arranged between one of the two locking portions 31 and one of the two limit portions 32. An elastic member 38 is mounted between the operation portion 33 and the column 23 to provide a returning force to the locking member 30.

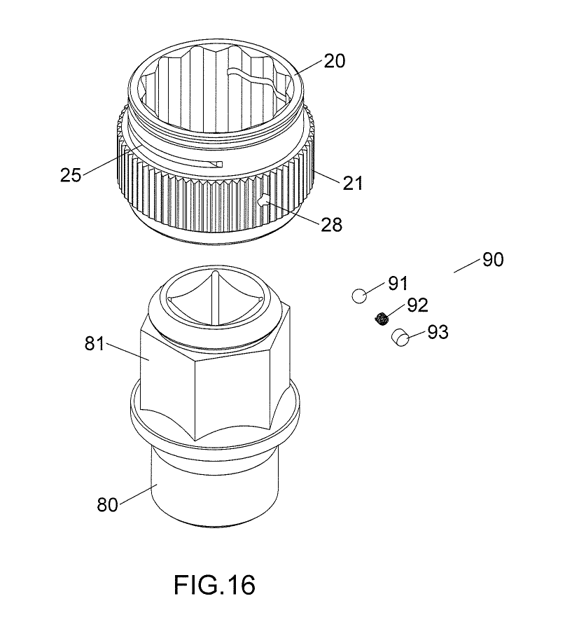

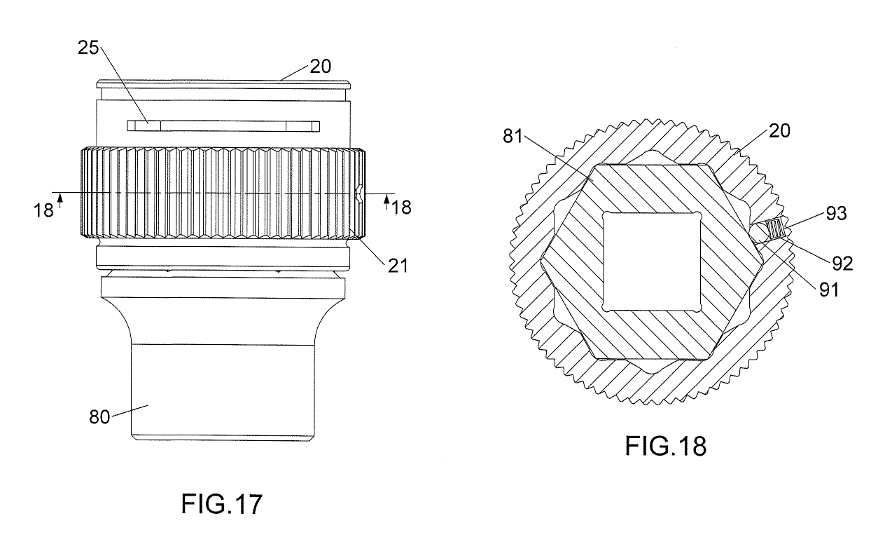

Referring to FIGS. 16-18, the ratchet portion 21 is provided with a receiving space 28 connected to the first mounting portion 24. A retaining unit 90 is mounted in the receiving space 28 and includes a ball 91 extending into the first mounting portion 24 and pressing a peripheral face of the connecting implement 80, a fixed member 93 secured in the receiving space 28, and a spring 92 biased between the ball 91 and the fixed member 93 to push the ball 91 toward the connecting implement 80. When the two locking portions 31 of the locking member 30 are detached from the third retaining groove 82 of the connecting implement 80, the connecting implement 80 is released from the locking member 30 and is still limited by the retaining unit 90, so that the connecting implement 80 is not detached from the ratchet wheel 20. When a force is applied on the connecting implement 80 to overcome the friction of the ball 91, the connecting implement 80 is removed from the first mounting portion 24 of the ratchet wheel 20.

Accordingly, the wrench has the following advantages:

1. The wrench only needs a single locking member 30 to be mounted on the ratchet wheel 20, thereby decreasing the cost of fabrication.

2. The locking member 30 is formed by stamping without needing other working procedures, thereby decreasing the cost of production.

3. The locking member 30 has two limit portions 32 resting on the column 23 so that the locking member 30 is not detached from the ratchet wheel 20 by restriction of the two limit portions 32. In assembly of the locking member 30, the locking member 30 is initially expanded outward so that the two locking portions 31 are mounted in the two first slots 25 of the ratchet wheel 20.

4. When the locking member 30 is driven by the operation portion 33 to move in the two first slots 25 of the ratchet wheel 20, the two fourth abutting portions 34 press the two third abutting portions 251, so that the two locking portions 31 are expanded outward to detach from the inscribed circle 243 of the first mounting portion 24, and the two limit portions 32 are spaced from the peripheral face of the column 23. When the operation portion 33 of the locking member 30 is released, the locking member 30 is returned automatically to the original position by action of the two fourth abutting portions 34 and the two third abutting portions 251.

5. When the locking member 30 is moved in the two first slots 25 of the ratchet wheel 20, the two fourth abutting portions 34 are pressed outward by the two third abutting portions 251, so that the two locking portions 31 are expanded outward and detached from the third retaining groove 82, thereby releasing the connecting implement 80 from the locking member 30, and thereby detaching the connecting implement 80 from the first mounting portion 24 of the ratchet wheel 20.

6. When the two locking portions 31 of the locking member 30 are detached from the third retaining groove 82 of the connecting implement 80, the connecting implement 80 is released from the locking member 30 and is still limited by the retaining unit 90, so that the connecting implement 80 is not detached from the ratchet wheel 20. When a force is applied on the connecting implement 80 to overcome the friction of the ball 91, the connecting implement 80 is removed from the first mounting portion 24 of the ratchet wheel 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench comprising:
a wrench body, a ratchet wheel, a locking member, a first cover, a first snap ring, a second cover and a second snap ring; wherein:
the wrench body is provided with a first receiving recess;
the first receiving recess has a first end provided with a first abutting portion and a second end provided with a second receiving recess;
the second receiving recess has a periphery provided with a first retaining groove;
the ratchet wheel is rotatably mounted in the first receiving recess and has a periphery provided with a ratchet portion which has a second abutting portion abutting the first abutting portion;
the ratchet wheel is provided with a recessed first mounting portion which has a plurality of concave portions and a plurality of convex portions arranged in an alternating manner;
the convex portions are arranged in an inscribed circle of the first mounting portion;
the ratchet wheel is provided with a column protruding from the first receiving recess;
the column is provided with a second retaining groove;
the column is provided with two first slots connected to the first mounting portion;
each of the two first slots has a length covering at least one of the concave portions and at least one of the convex portions;
the ratchet wheel is provided with two third abutting portions;
the locking member is movably mounted in the two first slots of the ratchet wheel;
the locking member is elastic and has a U-shaped profile;
the locking member has an operation portion, two fourth abutting portions, two locking portions and two limit portions;
the two fourth abutting portions abut the two third abutting portions;
each of the two fourth abutting portions has an oblique shape;
the two locking portions extend into the inscribed circle of the first mounting portion;
the two limit portions rest on the column;
the first cover is mounted on the wrench body and covers the ratchet wheel and the locking member, with the second retaining groove and the operation portion protruding from the first cover;
the first cover is provided with a receiving portion including two second slots and two third slots;
the two second slots receive the two fourth abutting portions;
the two third slots receive the two limit portions;
the first snap ring is mounted in the second retaining groove of the ratchet wheel and abuts the first cover;
the second cover is mounted in the second receiving recess of the wrench body and abuts the ratchet wheel; and
the second snap ring is mounted in the first retaining groove of the wrench body and abuts the second cover.

2. The wrench in accordance with claim 1, wherein the first mounting portion has a hexagonal or dodecagonal shape.

3. The wrench in accordance with claim 1, wherein each of the two third abutting portions is arranged on an arcuate face of the column, is located adjacent to one of the two first slots and has an arcuate shape.

4. The wrench in accordance with claim 1, wherein the length of each of the two first slots covers three of the concave portions and two of the convex portions.

5. The wrench in accordance with claim 1, wherein each of the two fourth abutting portions is arranged between the operation portion and one of the two locking portions, and each of the two locking portions is arranged between one of the two fourth abutting portions and one of the two limit portions.

6. The wrench in accordance with claim 1, wherein the wrench further comprises a connecting implement mounted on the ratchet wheel, the connecting implement is provided with a second mounting portion mounted on the first mounting portion of the ratchet wheel, the second mounting portion is provided with a third retaining groove, the two locking portions of the locking member are mounted in the two first slots of the ratchet wheel and the third retaining groove, and when the locking member is moved in the two first slots of the ratchet wheel, the two locking portions are expanded outward to detach from the third retaining groove.

7. The wrench in accordance with claim 6, wherein the connecting implement is provided with a conic face, and the third retaining groove is located between the second mounting portion and the conic face.

8. The wrench in accordance with claim 1, wherein the ratchet wheel is provided with a vertical line, and each of the two locking portions of the locking member has a projection provided with a normal line which is spaced from the vertical line, with the vertical line being located between the normal line 35 and the operation portion.

9. The wrench in accordance with claim 1, wherein the length of each of the two first slots covers one of the concave portions and two of the convex portions.

10. The wrench in accordance with claim 1, wherein each of the two third abutting portions is provided on a face of one of the two first slots, and each of the two fourth abutting portions is arranged between one of the two locking portions and one of the two limit portions.

11. The wrench in accordance with claim 1, wherein an elastic member is mounted between the operation portion and the column.

12. The wrench in accordance with claim 6, wherein the ratchet portion is provided with a receiving space connected to the first mounting portion, a retaining unit is mounted in the receiving space and includes a ball extending into the first mounting portion and pressing a peripheral face of the connecting implement, a fixed member secured in the receiving space, and a spring biased between the ball and the fixed member to push the ball toward the connecting implement.
